(19) United States
(12) Patent Application Publication
(10) Pub. No.: US 2017/0314405 A1
(43) Pub. Date: Nov. 2, 2017

(54) TRANSITION DUCT EXIT FRAME WITH INSERT

(71) Applicant: Siemens Aktiengesellschaft, München (DE)

(72) Inventors: Benjamin G. HETTINGER, Jupiter, FL (US); James BERTONCELLO, Charlotte, NC (US); Anthony L. SCHIAVO, Oviedo, FL (US); Timothy A. FOX, Hamilton (CA); Reinhard SCHILP, Winter Park, FL (US)

(21) Appl. No.: 15/525,349

(22) PCT Filed: Nov. 18, 2014
(86) PCT No.: PCT/US2014/066036

§ 371 Date: May 9, 2017

(51) Int. Cl. F01D 9/02; F01D 25/28

(52) U.S. Cl. CPC F01D 9/023; F01D 25/28; F05D 2220/32; F05D 2300/50212; F05D 2260/30

(57) ABSTRACT

A transition exit frame (10) for supporting a transition (12) extending downstream from a combustor (14) to a turbine assembly (16) in a turbine engine (18) and including one or more transition exit frame inserts (20) configured to reduce thermal distortion created during operation of the turbine engine (18) is disclosed. The transition exit frame (10) may be formed from one or more transition exit frame bodies (22). The transition exit frame body (22) may be formed from a first material (24) having a first coefficient of thermal expansion. The transition exit frame insert (20) may form at least a portion of the transition exit frame body (22). The transition exit frame insert (20) may be formed from a second material (26) having a second coefficient of thermal expansion that is different than the first coefficient of thermal expansion of the first material (24) to reduce distortion within the transition exit frame body (22) during operation of the turbine engine (18).

### FIELD OF THE INVENTION

The invention relates in general to combustion turbine engines and, more specifically, to transition ducts for routing combustor exhaust gas flow from combustors to a turbine assembly of a combustion turbine engine.

### BACKGROUND OF THE INVENTION

Typically, gas turbine engines include a compressor for compressing air, a combustor for mixing the compressed air with fuel and igniting the mixture, and a turbine blade assembly for producing power. Transition ducts extend between a combustor and a turbine blade assembly to direct combustor gases through the turbine blade assembly to impart rotational movement on the rotor of the turbine blade assembly. Conventional transition ducts are typically formed from a plenum that requires support from more rigid mounting support structure at the exit that is welded to the plenum. The rigid support structure is used for affixing the transition assembly to the turbine inlet. This rigid support structure is also used to support the exit seals that are used to prevent cold compressed air from entering into the turbine directly.

During operation, gas turbine engines operate at high temperatures and expose the transition ducts to hot combustion gases. As such, the bottom rail of the transition exit frame may frown due to thermal expansion. In addition, the upper rail may flatten due to thermal expansion. Thus, a need exists for a transition exit frame better suited to handle thermal expansion during turbine engine operation.

### SUMMARY OF THE INVENTION

A transition exit frame for supporting a transition extending downstream from a combustor to a turbine assembly in a turbine engine and including one or more transition exit frame inserts configured to reduce thermal distortion created during operation of the turbine engine is disclosed. The transition exit frame may be formed from one or more transition exit frame bodies. The transition exit frame body may be formed from a first material having a first coefficient of thermal expansion. The transition exit frame insert may form at least a portion of the transition exit frame body. The transition exit frame insert may be formed from a second material having a second coefficient of thermal expansion that is different than the first coefficient of thermal expansion of the first material to reduce distortion within the transition exit frame body during operation of the turbine engine.

In at least one embodiment, the transition exit frame for supporting a transition in a turbine engine may include one or more transition exit frame bodies having at least one transition duct body receiver for receiving a downstream end of one or more transition duct bodies. The transition exit frame body may be formed from a first material having a first coefficient of thermal expansion and one or more transition exit frame inserts forming at least a portion of the transition exit frame body. The transition exit frame insert may be formed from a second material having a second coefficient of thermal expansion that is different than the first coefficient of thermal expansion of the first material to reduce distortion within the transition exit frame body during operation of the turbine engine.

In at least one embodiment, the transition exit frame insert may be formed from a circumferentially curved body that is used to form at least a portion of a radially inner support beam of the transition exit frame body. The transition exit frame insert may be formed from a circumferentially curved body that is used to form at least a portion of a radially inner support beam of the transition exit frame body such that the transition exit frame insert extends from a first side edge of the transition exit frame body to a second side edge of the transition exit frame body. The transition exit frame insert may be centered relative to a radially extending centerline of the transition exit frame body. The transition exit frame insert may be formed from a plurality of transition exit frame inserts that each are formed from a circumferentially curved body that is used to form at least a portion of a radially inner support beam of the transition exit frame body. A first transition exit frame insert may be positioned within a left side half of the radially inner support beam and a second transition exit frame insert may be positioned within a right side half of the radially inner support beam.

In at least one embodiment, the transition exit frame insert may be formed from a circumferentially curved body that is used to form at least a portion of a radially outer support beam of the transition exit frame body. The transition exit frame insert may form one or more connection arms having one or more connection orifices therein. The transition exit frame body may be formed from first and second connection arms extending radially outward with at least one transition exit frame insert forming at least one connection arm having at least one connection orifice therein. In at least one embodiment, the transition exit frame insert may be positioned between the first and second connection arms. In another embodiment, the transition exit frame insert may form an entirety of the radially outer support beam of the transition exit frame body. The transition exit frame insert includes a plurality of connection arms extending radially outward therefrom. In at least one embodiment, each of the plurality of connection arms has at least one connection orifice therein. The connection arm may be formed from two generally opposed sides and a radially outward tip.

An advantage of this invention is that by using a second material having a second coefficient of thermal expansion that is different than the first coefficient of thermal expansion of the first material to form the transition exit frame insert, the transition exit frame insert may reduce frowning of a radially inner support beam and to reduce flattening of a radially outer support beam of the transition exit frame.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a perspective view of a gas turbine engine including a transition exit frame supporting a transition extending downstream from a combustor to a turbine assembly.

FIG. 2 is a partial cross-sectional side view of a transition extending downstream from a combustor to a turbine assembly, whereby the transition is supported by a transition exit frame.

FIG. 3 is an end view of an embodiment of a transition exit frame including a transition exit frame insert positioned within a radially inner support beam of the transition exit frame and extending from a first side edge to a second side edge.

FIG. 4 is an end view of another embodiment of a transition exit frame including a transition exit frame insert positioned within a radially inner support beam of the transition exit frame.

FIG. 5 is an end view of yet another embodiment of a transition exit frame including a plurality of transition exit frame inserts positioned within a radially inner support beam of the transition exit frame. FIG. 6 is an end view of another embodiment of a transition exit frame including a transition exit frame insert positioned within a radially outer support beam of the transition exit frame.

FIG. 7 is an end view of still another embodiment of a transition exit frame including a transition exit frame insert positioned within a radially outer support beam of the transition exit frame, extending from a first side edge to a second side edge and forming a plurality of connection arms.

FIG. 8 is an end view of another embodiment of a transition exit frame including a transition exit frame insert positioned within a radially outer support beam of the transition exit frame and a transition exit frame insert positioned within a radially inner support beam of the transition exit frame.

FIG. 9 is an end view of yet another embodiment of a transition exit frame including a transition exit frame insert forming a radially outer portion of the exit frame.

### DETAILED DESCRIPTION OF EMBODIMENTS OF THE INVENTION

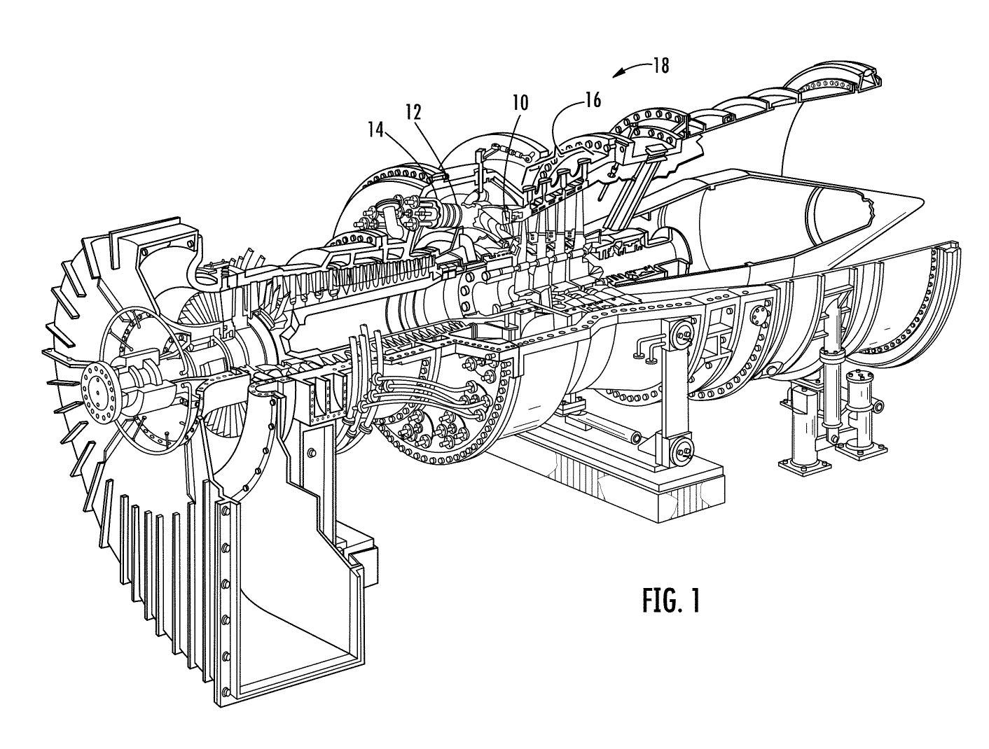

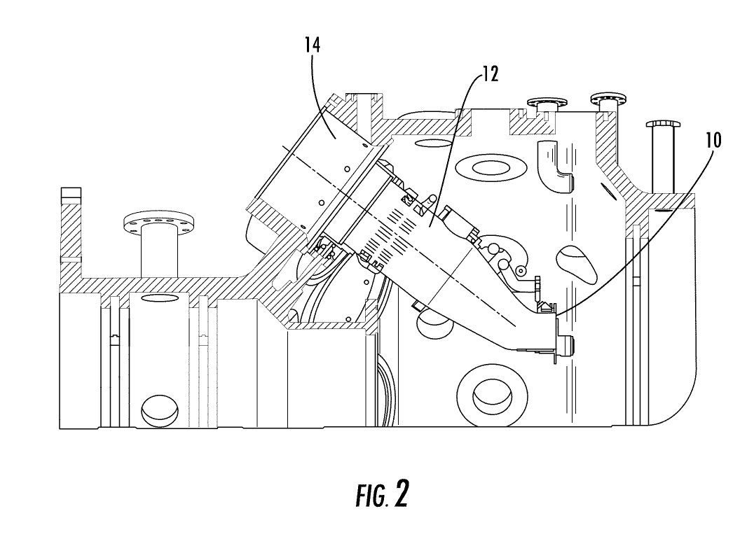

As shown in FIGS. 1-9, a transition exit frame 10 for supporting a transition 12 extending downstream from a combustor 14 to a turbine assembly 16 in a turbine engine 18 and including one or more transition exit frame inserts 20 configured to reduce thermal distortion created during operation of the turbine engine 18 is disclosed. The transition exit frame 10 may be formed from one or more transition exit frame bodies 22. The transition exit frame body 22 may be formed from a first material 24 having a first coefficient of thermal expansion. The transition exit frame insert 20 may form at least a portion of the transition exit frame body 22. The transition exit frame insert 20 may be formed from a second material 26 having a second coefficient of thermal expansion that is different than the first coefficient of thermal expansion of the first material 24 to reduce distortion within the transition exit frame body 22 during operation of the turbine engine 18.

In at least one embodiment, the transition exit frame 10 for supporting a transition 12 in a turbine engine 18 may be formed from one or more transition exit frame bodies 22 having one or more transition duct body receivers 28 for receiving a downstream end 30 of one or more transition duct bodies 32. The transition exit frame body 22 may be formed from a first material 24 having a first coefficient of thermal expansion. The first material 24 may be, but is not limited to being, INCO 617, Hast-x or other nickel based alloys. The transition exit frame insert 20 may form at least a portion of the transition exit frame 22. The transition exit frame insert 20 may be formed from a second material 26 having a second coefficient of thermal expansion that is different than the first coefficient of thermal expansion of the first material 24 to reduce distortion within the transition exit frame body 22 during operation of the turbine engine 18. By using a second material 26 having a second coefficient of thermal expansion that is different than the first coefficient of thermal expansion of the first material 24 to form the transition exit frame insert 20, the transition exit frame insert 20 may reduce frowning of a radially inner support beam 32 and to reduce flattening of a radially outer support beam 34 of the transition exit frame 10. The second material 26 may be, but is not limited to being, stainless steel or a material with a high thermal expansion coefficient than the first material.

As shown in FIGS. 3-5, the transition exit frame insert 20 may be formed from a circumferentially curved body 36 that is used to form at least a portion of the radially inner support beam 32 of the transition exit frame body 22. As shown in FIG. 3, the transition exit frame insert 20 may be formed from a circumferentially curved body 36 that extends from a first side edge 38 of the transition exit frame body 22 to a second side edge 40 of the transition exit frame body 22. In at least one embodiment, as shown in FIG. 4, the transition exit frame insert 20 may be centered relative to a radially extending centerline 42 of the transition exit frame body 22. In another embodiment, as shown in FIG. 5, the transition exit frame insert 20 may be formed from a plurality of transition exit frame inserts 20 that each form from a circumferentially curved body 36 that is used to form at least a portion of a radially inner support beam 32 of the transition exit frame body 22. As shown in FIG. 5, a first transition exit frame insert 44 may be positioned within a left side half 46 of the radially inner support beam 32 and a second transition exit frame insert 48 may be positioned within a right side half 50 of the radially inner support beam 32. The first transition exit frame insert 44 may be centered along a centerline 54 positioned about halfway between the first side edge 38 and a midpoint 56 on the radially inner support beam 32. The second transition exit frame insert 48 may be centered along a centerline 58 positioned about halfway between the second side edge 40 and centerline 42 on the radially inner support beam 32.

In at least one embodiment, as shown in FIGS. 6-8, the transition exit frame insert 20 may be formed from a circumferentially curved body 36 that is used to form at least a portion of a radially outer support beam 34 of the transition exit frame body 22. The transition exit frame insert 20 may form one or more connection arms 60 having one or more connection orifices 62 therein. In at least one embodiment, the connection arm 60 may be formed from a two generally opposed sides 64, 66 and a radially outward tip 68. In at least one embodiment, the two generally opposed sides 64, 66 may be generally linear, and the radially outward tip 68 may be generally linear. The sides 64, 66 may be positioned nonparallel and nonorthogonal relative to each other such that the sides 64, 66 are angled towards each other. In at least one embodiment, the sides 64, 66 may have equal length. The sides 64, 66 may have a substantially same length as the radially outward tip 68. In at least one embodiment, the transition exit frame body 22 may include first and second connection arms 70, 72 extending radially outward with one or more transition exit frame inserts 20 forming one or more connection arms 60 having at least one connection orifice 62 therein.

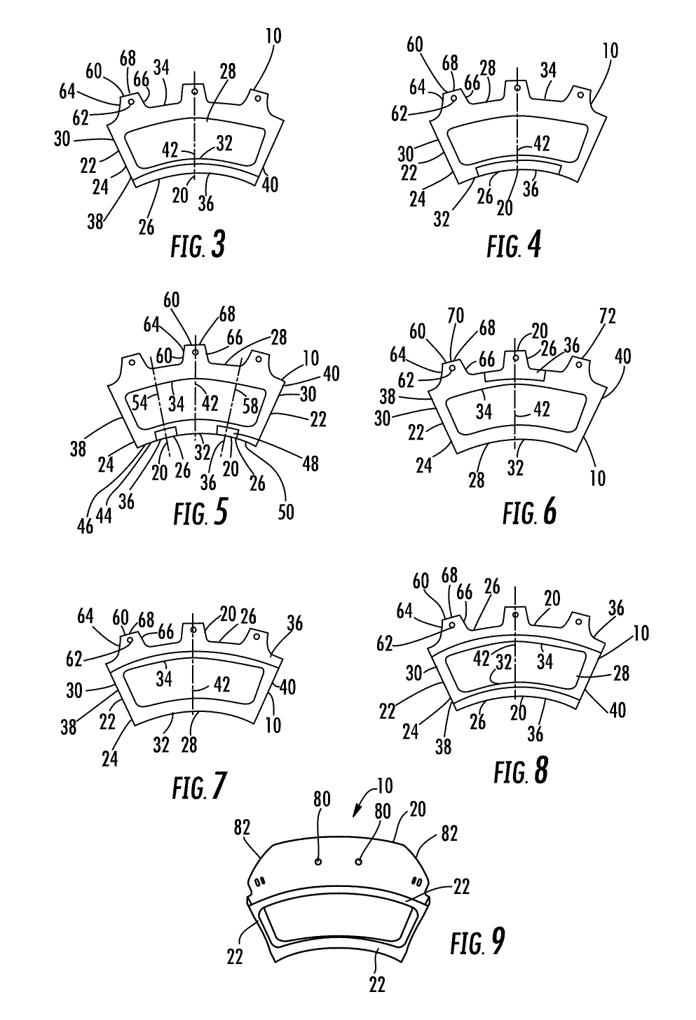

In at least one embodiment, as shown in FIG. 6, the transition exit frame insert 20 may be positioned between the first and second connection arms 70, 72. In another embodiment, as shown in FIGS. 7-8, the transition exit frame insert 20 may form an entirety of the radially outer support beam 34 of the transition exit frame body 22. The transition exit frame insert 20 may include a plurality of connection arms 60 extending radially outward therefrom. The plurality of connection arms 60 may include at least one connection orifice 62 therein. In at least one embodiment, the connection arms 60 may each include one or more connection orifices 62 therein.

In yet another embodiment, as shown in FIG. 9, the transition exit frame insert 20 may form a radially outer portion of the transition exit frame body 22. The transition exit frame insert 20 may include two or more attachment orifices 80. The attachment orifices 80 may have any appropriate configuration. The transition exit frame insert 20 may include notches 82 in radially outward corners. The notches 82 may have any appropriate configuration, but are not required. The configuration of the transition exit frame insert 20 may be such that the transition exit frame insert 20 forms a larger portion of the transition exit frame 10 than remaining portions of the transition exit body 22.

The foregoing is provided for purposes of illustrating, explaining, and describing embodiments of this invention. Modifications and adaptations to these embodiments will be apparent to those skilled in the art and may be made without departing from the scope or spirit of this invention.

1-13. (canceled)

14. A transition exit frame for supporting a transition in a turbine engine, comprising:
at least one transition exit frame body having at least one transition duct body receiver for receiving a downstream end of at least one transition duct body;
wherein the at least one transition exit frame body is formed from a first material having a first coefficient of thermal expansion;
at least one transition exit frame insert forming at least a portion of the at least one transition exit frame body; and
wherein the at least one transition exit frame insert is formed from a second material having a second coefficient of thermal expansion that is different than the first coefficient of thermal expansion of the first material to reduce distortion within the at least one transition exit frame body during operation of the turbine engine,
wherein the at least one transition exit frame insert is formed from a circumferentially curved body that is used to form at least a portion of a radially outer support beam of the at least one transition exit frame body,
wherein the at least one transition exit frame insert forms at least one connection arm having at least one connection orifice therein.

15. The transition exit frame of claim 14, wherein the at least one transition exit frame insert is formed from a circumferentially curved body that is used to form at least a portion of a radially inner support beam of the at least one transition exit frame body.

16. The transition exit frame of claim 15, wherein the at least one transition exit frame insert is formed from a circumferentially curved body that is used to form at least a portion of a radially inner support beam of the at least one transition exit frame body such that the at least one transition exit frame insert extends from a first side edge of the at least one transition exit frame body to a second side edge of the at least one transition exit frame body.

17. The transition exit frame of claim 14, wherein the at least one transition exit frame insert is centered relative to a radially extending centerline of the at least one transition exit frame body.

18. The transition exit frame of claim 14, wherein the at least one transition exit frame insert is formed from a plurality of transition exit frame inserts that each form from a circumferentially curved body that is used to form at least a portion of a radially inner support beam of the at least one transition exit frame body.

19. The transition exit frame of claim 18, wherein a first transition exit frame insert is positioned within a left side half of the radially inner support beam and a second transition exit frame insert is positioned within a right side half of the radially inner support beam.

20. The transition exit frame of claim 14, wherein the at least one transition exit frame body comprises first and second connection arms extending radially outward with at least one transition exit frame insert forming at least one connection arm having at least one connection orifice therein, wherein the at least one transition exit frame insert is positioned between the first and second connection arms.

21. A transition exit frame for supporting a transition in a turbine engine, comprising:
at least one transition exit frame body having at least one transition duct body receiver for receiving a downstream end of at least one transition duct body;
wherein the at least one transition exit frame body is formed from a first material having a first coefficient of thermal expansion;
at least one transition exit frame insert forming at least a portion of the at least one transition exit frame body; and
wherein the at least one transition exit frame insert is formed from a second material having a second coefficient of thermal expansion that is different than the first coefficient of thermal expansion of the first material to reduce distortion within the at least one transition exit frame body during operation of the turbine engine,
wherein the at least one transition exit frame insert forms an entirety of the radially outer support beam of the at least one transition exit frame body,
wherein the at least one transition exit frame insert includes a plurality of connection arms extending radially outward therefrom.

22. The transition exit frame of claim 21, wherein each of the plurality of connection arms has at least one connection orifice therein.

23. The transition exit frame of claim 14, wherein the at least one connection arm is formed from two generally opposed sides and a radially outward tip.
